(19) United States
(12) Patent Application Publication
(10) Pub. No.: US 2024/0316739 A1
(43) Pub. Date: Sep. 26, 2024

(54) SOFT-FACED DEAD BLOW HAMMER

(71) Applicant: Snap-on Incorporated, Kenosha, WI (US)

(72) Inventor: Scott A. Bendorf, Kenosha, WI (US)

(73) Assignee: Snap-on Incorporated, Kenosha, WI (US)

(21) Appl. No.: 18/124,270

(22) Filed: Mar. 21, 2023

(51) Int. Cl. B25D 1/14; B25D 1/12

(52) U.S. Cl. CPC B25D 1/14; B25D 1/12

(57) ABSTRACT

A hammer tool including a single body and over-molded with one or more materials configured to improve the performance of the hammer is disclosed. The hammer may be formed with a single piece hammer head defining a cavity at least partially filled with a flowable material, such as steel shot. The striking surfaces of the hammer may be reinforced by a woven fabric or fiber reinforced polymers. The resulting hammer body and cavity has fewer or no joints or seams for shot to escape and provides material properties to be optimized in different areas of the hammer over-mold.

### TECHNICAL FIELD OF THE INVENTION

The present invention relates generally to hammer tools, more specifically to a dead blow hammer with a covered or over-molded metal head.

### BACKGROUND OF THE INVENTION

Traditional soft-faced, dead blow hammers include an internal cavity filled with a flowable material, typically steel shot, surrounded by a deformable, relatively soft material (typically elastomer, such as polyurethane). The cavity is typically created by a length of pipe or tube, which is capped and sealed with press-fit metal end caps. However, this junction between the body and the end caps can be a weak point for failure of the hammer body, which can allow flowable material to escape.

Additionally, traditional dead blow hammers may be compromised by a manufacturer prioritizing either ease of manufacture or durability. An end cap that can be easily assembled by creating an interference fit between the end caps and the hammer body, for example, by crimping, may not result in a robust and durable design. Further, known dead blow hammers use press-fit end caps. Many manufacturers crimp the ends caps on the hammer body or have a plastic shot cavity that can be more easily sealed by adhesive or welding, but does not provide the same mass as a steel-bodied hammer.

Traditional hammers are also commonly over-molded with a single material. This requires the head of the hammer to be placed in a mold with pins that provide a potential path to contaminate the work area with steel shot, exposing the hammer head to potential damage. Additionally, such designs do not allow different areas of the hammer over-mold to be easily optimized for comfort, cost, and durability.

### SUMMARY OF THE INVENTION

The present invention relates broadly to a dead blow hammer with single piece metal hammer head body. The hammer may be covered or over-molded with multiple, differing materials having cooperative properties designed to improve different aspects of hammer performance. According to an embodiment, a dead blow hammer may include a handle and a head coupled to the handle. The head may define a void or cavity and a striking end. The cavity is partially or substantially filled with a flowable material. A reinforcement layer may be coupled to the striking end of the head. An over-mold may further couple the head and handle.

According to another embodiment, a hammer tool may include a handle having opposing first and second ends and a single-piece or unitary head coupled to the first end of the handle. The head may define a cavity between opposing first and second striking ends. The cavity may be partially or substantially filled with a flowable material. An over-mold may be disposed about the handle and the first and second striking ends of the head. A ballistic reinforcement layer may be coupled to the over-mold.

According to an embodiment, a hammer may include a handle having opposing first and second ends. The hammer may also include a single-piece head coupled to the first end of the handle. The head may define a cavity between opposing first and second striking ends. The cavity may be partially or substantially filled with a flowable material. First and second striking end caps may be respectively coupled to the first and second striking ends. An over-mold may couple the handle, the first and second striking ends of the head, and the first and second striking end caps, together. First and second ballistic reinforcement layers may be respectively coupled to the first and second striking end caps.

### BRIEF DESCRIPTION OF THE DRAWINGS

For purposes of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a side view of a hammer tool, according to an embodiment of the present invention.

FIG. 2 is a top, partial sectional view of the hammer tool of FIG. 1, taken across line D-D in FIG. 1, according to an embodiment of the present invention.

FIG. 3 is a top view of a hammer tool, according to an embodiment of the present invention.

FIG. 4 is an enlarged, partial sectional view of the tool of FIG. 3, taken across line A-A in FIG. 3, according to an embodiment of the present invention.

FIG. 5 is an enlarged side-view of a head of a hammer tool, according to an embodiment of the present invention.

FIG. 6 is a side view of a hammer tool, according to an embodiment of the present invention.

FIG. 7 is a top view of the hammer tool of FIG. 6, according to an embodiment of the present invention.

### DETAILED DESCRIPTION

While the present invention is susceptible of embodiments in many different forms, there is shown in the drawings, and will herein be described in detail, embodiments of the invention, including a preferred embodiment, with the understanding that the present disclosure is to be considered as an exemplification of the principles of the present invention and is not intended to limit the broad aspect of the invention to any one or more embodiments illustrated herein. As used herein, the term “present invention” is not intended to limit the scope of the claimed invention, but is instead used to discuss exemplary embodiments of the invention for explanatory purposes only.

The present invention relates broadly to a hammer tool, such as a dead blow hammer, composed or formed of a single body and over-molded with one or more materials that are configured to cooperatively improve the performance of the hammer. According to an embodiment, the hammer may be formed with a single piece hammer head using a forming process, such as, for example, rotary spin-forming, to close the end of a length of pipe on both opposing ends. The resulting hammer body and cavity minimizes joints or seams that may result in failure with shot escaping. The hammer also allows for material properties to be optimized in different areas of the hammer over-mold.

According to an embodiment, the body of the hammer head may be composed of a single piece of pipe or tube including or forming a cavity with closed ends. The ends of the body may have a flat, radiused, or combination of flat, angled, and radiused, surface. The hammer head may be closed after the head is partially or substantially filled with flowable material, such as steel shot, will be create the dead blow effect of the hammer. This flowable material may be loose or encased in a separate bladder, enclosure, or pouch disposed in the cavity. Moreover, the hammer head may also be filled with the flowable material after the ends are closed through an opening created in the body, which may later be sealed by welding or a plug.

According to an embodiment, the handle may be composed of a fiber/polymer composite, and may be coupled to the head by means of a neck tube welded to the head. This tube may be welded or otherwise fastened to the face, and may have a closed end that can be inserted into the shot filling opening seal the head. The handle may be held in this tube by adhesive or mechanical fastener, such as a pin.

The hammer may be partially or wholly covered by an over-mold, such as, for example, a relatively elastomeric or soft material, such as polyurethane. According to an embodiment, the hammer may include different material types in specific areas of the hammer. For example, the hand grip area may have a softer, elastomeric material for better comfort, especially during dead blow use of the hammer. The striking ends of the hammer may include or be composed of a material with improved tear strength and low resilience for better durability and damping effect. This may also be accomplished by embedding reinforcement in the hammer over-mold in specific areas. This reinforcement may be a material like fiberglass or Kevlar fibers, and may take the form of woven fabric or fiber reinforced polymers. According to an embodiment, the softened face ends may be separate components or caps having substantially the same diameter as the finished hammer head. Accordingly, the need to use locating pins in the head during over-molding the rest of the hammer is negated. These caps may rely on a mechanical joining, chemical adhesion, or a combination, for securing to the hammer head and/or over-mold.

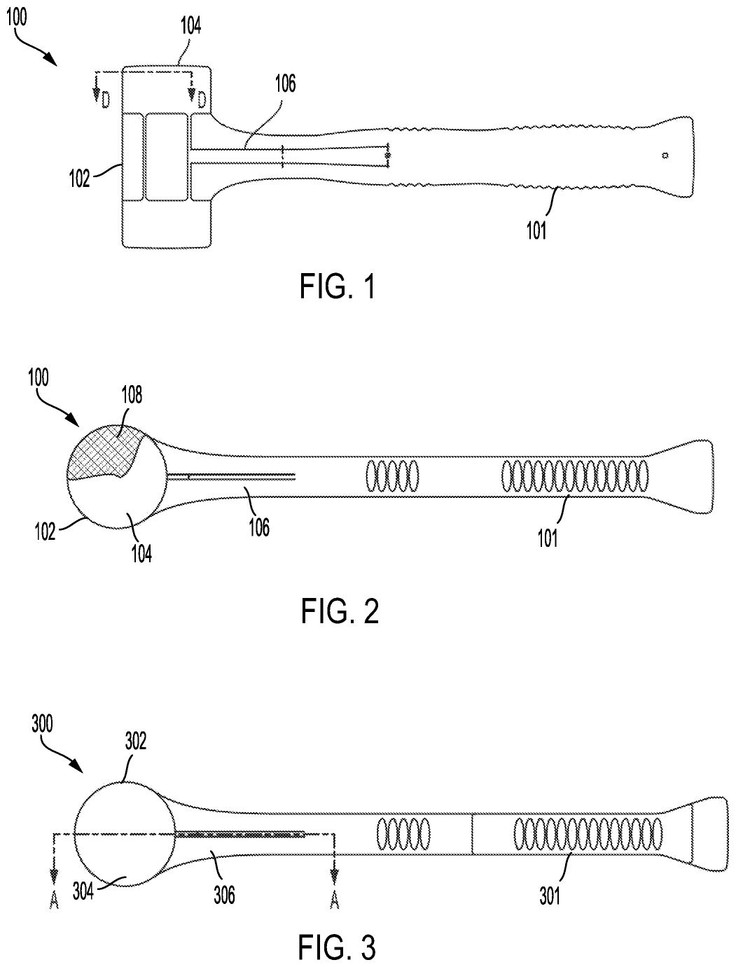

Referring to FIGS. 1-2, an embodiment of a hammer tool 100, such as a dead blow hammer, according to an embodiment of the present invention is depicted. The hammer 100 may include a handle 101 coupled to a head 102. The handle 101 may include a gripping surface (as shown in FIG. 2) that may include, for example, ridges, grooves, or the like configured to provide better friction between a user's hand and the hammer during use. The handle 101 and/or head 102 may include an over-mold 106 composed of a soft or elastomeric material, such as polyurethane, and may include or define one or more opposing striking ends 104 configured to impact a workpiece (not shown). According to an embodiment, the striking ends 104 may include fiberous reinforcements 108 embedded in the striking end material to structurally reinforce the striking ends and to minimize damage. According to an embodiment, the fiberous reinforcements may include one or multiple layers of a fabric/polymer matrix that forms a distinct “ballistic layer” embedded in the over-mold material. As described herein, the fiber-reinforced striking ends 104 may increase the strength, durability, and dampening of the hammer during use.

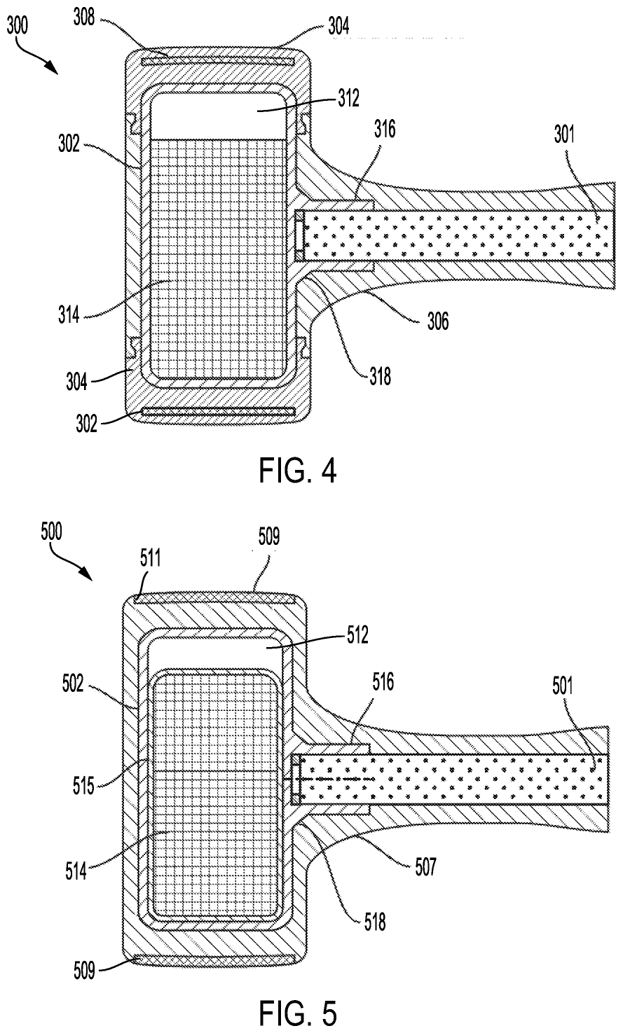

Referring to FIGS. 3-4, another embodiment of a hammer tool 300, such as a dead blow hammer, is depicted. Like the tool of FIGS. 1-2, the hammer 300 may include a handle 301 coupled to a single-piece head 302. The head may include a neck tube 316 configured to receive and engage the handle 301, for example by a weld 318 or other suitable bonding. The head 302 may include or form a cavity 312 into which flowable dead blow material 314, such as steel shot, or the like, may be disposed. The head 302 may be sealed by a weld or plug after disposing the dead blow material 314.

According to an embodiment, the head 302 may include one or more striking caps 304 coupled to the hammer over-mold 306 of the handle 301. The striking caps 304 may include one or more ballistic layers 308 formed of a fabric/polymer matrix embedded below and near the surface of the end caps 304.

Referring to FIG. 5, a hammer tool 500, such as a dead blow hammer, is shown according to another embodiment of the present invention. A composite handle 501 may be coupled to a neck tube 516 of the head 502. The neck tube 516 may be formed or coupled to the head 502 by a weld 518 or other suitable securement. The neck tube 516 may further be configured to plug a hole or recess that is used to dispose the fillable material 514 into the cavity 512 of the head 502. According to an embodiment, the coupled handle 501 and head 502 are substantially or partially encased in an over-mold 507. The over-mold 507 may include or define a recess 511 configured to receive one or more ballistic layers 509, as described herein, in the over-mold's surface.

According to an embodiment, the cavity 512 of the head 502 may include a bladder 515, pouch, enclosure, or the like that is adapted to hold the flowable material 514 in the cavity 512. The bladder 515 may be plastic, rubber, fabric, or other suitable material for ease of sealing and flexibility to fit inside the cavity 512. The bladder, pouch, enclosure, or the like, has the further benefit of better containing the flowable material.

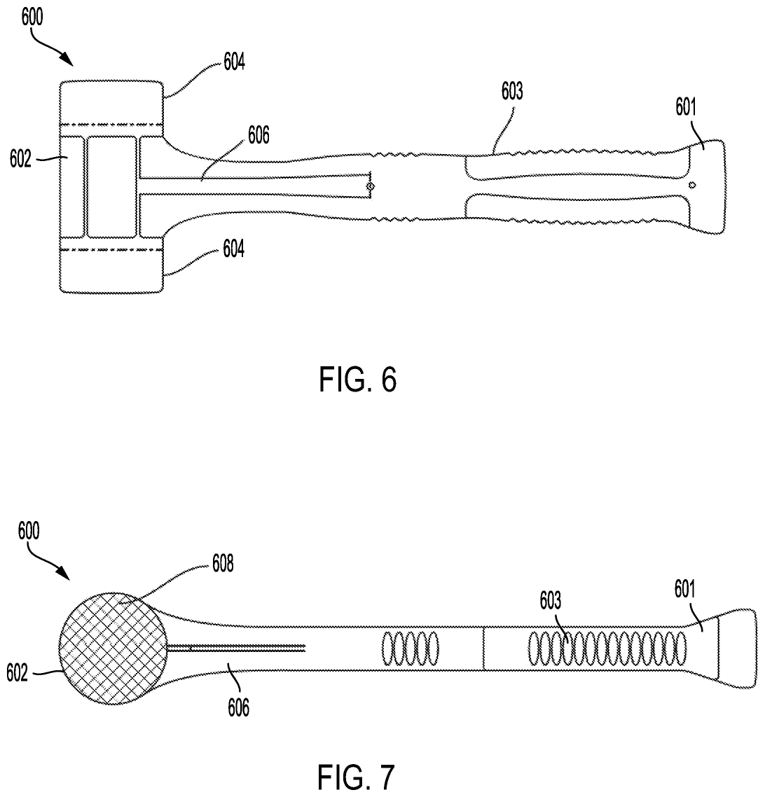

Referring to FIGS. 6-7, a hammer tool 600, such as a dead blow hammer, is shown, according to an embodiment of the present invention. The hammer 600 is similar to those previously described, having a handle 601 coupled to a head 602 and an over-mold 606 coupled to the handle, head, or both. The handle 601 may include or form a gripping section 603 adapted to provide better grip with a user's hand during use. The head 602 may be like any of the heads previously described, and may include striking end caps 604 coupled to the ends of the head 602. According to an embodiment, the striking end caps 604 may include or define a reinforcing fiber weave 608 or fiberglass, Kevlar, or the like, on the surface of the striking end caps 604. The reinforcing fiber weave 608 at the surface of the striking surfaces of the caps provides the hammer 600 with improved tear strength and lower resilience for better durability and damping.

As used herein, the term “coupled” and its functional equivalents are not intended to necessarily be limited to direct, mechanical coupling of two or more components. Instead, the term “coupled” and its functional equivalents are intended to mean any direct or indirect mechanical, electrical, or chemical connection between two or more objects, features, work pieces, and/or environmental matter. “Coupled” is also intended to mean, in some examples, one object being integral with another object. As used herein, the term “a” or “one” may include one or more items unless specifically stated otherwise.

As used herein terms denoting direction, order, or orientation such as “first,” “second,” “horizontal,” “vertical,” “lateral,” “top,” “bottom,” “left,” “right,” “over,” “under,” “above,” “below,” “front,” back,” or the like, are non-limiting and used herein for ease of explanation. One of skill in the art will recognize the use of these terms as merely descriptive examples that do not limit the placement, orientation, or disposition of the elements described using such terms.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

1. A hammer comprising:
a handle;
a head coupled to the handle, the head defining a cavity and a striking end, wherein the cavity is at least partially filled with a flowable material;
a reinforcement layer coupled to the striking end; and
an over-mold further coupling the head and handle.

2. The hammer of claim 1, wherein the reinforcement layer includes a polymer fabric.

3. The hammer of claim 2, wherein the polymer fabric includes fiberglass.

4. The hammer of claim 2, wherein the polymer fabric includes Kevlar.

5. The hammer of claim 1, wherein the reinforcement layer is embedded within the over-mold at the striking end of the head.

6. The hammer of claim 1, wherein the reinforcement layer is disposed on a striking surface of the over-mold.

7. The hammer of claim 1 further comprising a striking cap disposed on the at least one striking end of the head.

8. The hammer of claim 7, wherein the reinforcement layer is embedded in the striking cap.

9. The hammer of claim 8, wherein the reinforcement layer is disposed on a striking surface of the striking cap.

10. The hammer of claim 7, wherein the striking cap is coupled to the striking end by mechanical joining.

11. The hammer of claim 7, wherein the striking cap is coupled to the striking end by chemical joining.

12. The hammer of claim 1, wherein the flowable material includes steel shot.

13. The hammer of claim 1, further comprising a bladder disposed in the cavity, the flowable material being disposed in the bladder.

14. The hammer of claim 1, wherein the over-mold includes polyurethane.

15. The hammer of claim 1, wherein the handle includes a gripping section.

16. The hammer of claim 1, wherein the head include a neck tube, and the handle is welded to the neck tube.

17. The hammer of claim 1, wherein the head is a single-piece tube including closed ends.

18. The hammer of claim 17, wherein the ends includes a flat surface.

19. The hammer of claim 17, wherein the ends each include a radiused surface.

20. A hammer tool comprising:
a handle having opposing first and second ends;
a single-piece head coupled to the first end, the head defining a cavity disposed between first and second striking ends, the cavity at least partially filled with a flowable material;
an over-mold disposed about the handle and the first and second striking ends; and
a ballistic reinforcement layer coupled to the over-mold.

21. A hammer comprising:
a handle having opposing first and second ends;
a single-piece head coupled to the first end, the head including a cavity disposed between opposing first and second striking ends,
a flowable material at least partially filing the cavity;
first and second striking end caps respectively coupled to the first and second striking ends;
an over-mold coupling together the handle, the first and second striking ends, and the first and second striking end caps; and
first and second ballistic reinforcement layers respectively coupled to the first and second striking end caps.
